(19) United States
(12) Patent Application Publication
(10) Pub. No.: US 2023/0396178 A1
(43) Pub. Date: Dec. 7, 2023

(54) CAPACITY ISOLATED POWER CONVERSION DEVICE

(71) Applicant: KABUSHIKI KAISHA TOYOTA JIDOSHOKKI, Kariya-shi, Aichi-ken (JP)

(72) Inventors: Kazuto HIRAI, Kariya-shi (JP); Kenichi WATANABE, Kariya-shi (JP)

(73) Assignee: KABUSHIKI KAISHA TOYOTA JIDOSHOKKI, Kariya-shi, Aichi-ken (JP)

(21) Appl. No.: 18/032,465

(22) PCT Filed: Oct. 18, 2021
(86) PCT No.: PCT/JP2021/038384

§ 371 Date: Apr. 18, 2023

(30) Foreign Application Priority Data
Oct. 20, 2020 (JP) 2020-175864

(51) Int. Cl. H02M 3/335; H02M 3/00

(52) U.S. Cl. CPC H02M 3/33573; H02M 3/01

(57) ABSTRACT

A capacitive isolation type power conversion device includes a primary side circuit, which includes switching elements, a first connection line and a second connection line, which are connected to the primary side circuit, a first capacitor provided on the first connection line, a second capacitor provided on the second connection line, a third connection line, an excitation inductor provided on the third connection line, a secondary side circuit, and a control circuit. The control circuit controls a switching frequency, thereby controlling an output voltage, which is a voltage of DC power output from the secondary side circuit.

### TECHNICAL FIELD

The present disclosure relates to a capacitive isolation type power conversion device.

### BACKGROUND ART

Patent Literature 1 discloses an isolation type power conversion device that performs power transmission between a primary side circuit and a secondary side circuit using a transformer. In an isolation type power conversion device as disclosed in Patent Literature 1, power is transmitted between the primary side circuit and the secondary side circuit via a transformer. Accordingly, even when an anomaly occurs, DC power is unlikely to be transmitted between the primary side circuit and the secondary side circuit. This improves safety.

### CITATION LIST

### Patent Literature

Patent Literature 1: Japanese Laid-Open Patent Publication No. 2017-55536

### SUMMARY OF INVENTION

### Technical Problem

When a transformer is used in the above-described manner, the size and the weight of the transformer may increase the size and the weight of the power conversion device.

In this regard, a capacitive isolation type power conversion device may be employed that transmits power between a primary side circuit and a secondary side circuit using a capacitor instead of a transformer. However, when capacitors are used, it is difficult to control output voltage, which is a voltage output from the secondary side circuit.

It is an objective of the present disclosure to provide a capacitive isolation type power conversion device that is capable of controlling output voltage.

### Solution to Problem

In one general aspect of the present disclosure, a capacitive isolation type power conversion device includes a primary side circuit that includes a switching element, the primary side circuit being configured such that the switching element are alternately switched between an ON state and an OFF state at a specified switching frequency, so that an input power is converted to an AC power, a first connection line and a second connection line that are connected to the primary side circuit, a first capacitor provided on the first connection line, a second capacitor provided on the second connection line, a secondary side circuit that is connected to the primary side circuit by the first and second connection lines via the first and second capacitors, the secondary side circuit being configured to convert an AC power input from the first and second connection lines to a DC power, a third connection line that is provided closer to the secondary side circuit than the first capacitor and the second capacitor, the third connection line connecting the first connection line and the second connection line to each other, an excitation inductor provided on the third connection line, and a control unit configured to control the switching element. The control unit is configured to control an output voltage, which is a voltage of the DC power output from the secondary side circuit, by controlling the switching frequency, a duty cycle of the switching element, or a phase of the AC power flowing through the primary side circuit.

### BRIEF DESCRIPTION OF DRAWINGS

FIG. 1 is a circuit diagram showing one example of a capacitive isolation type power conversion device.

FIG. 2 is a graph showing a relationship between a switching frequency and a conversion ratio.

FIG. 3 is a circuit diagram showing a capacitive isolation type power conversion device according to a modification.

FIG. 4 is a circuit diagram showing a capacitive isolation type power conversion device according to another modification.

### DESCRIPTION OF EMBODIMENTS

A capacitive isolation type power conversion device 10 according to one embodiment will now be described. The capacitive isolation type power conversion device described below is merely one example, and the present disclosure is not limited to the contents of the capacitive isolation type power conversion device 10 of the present embodiment.

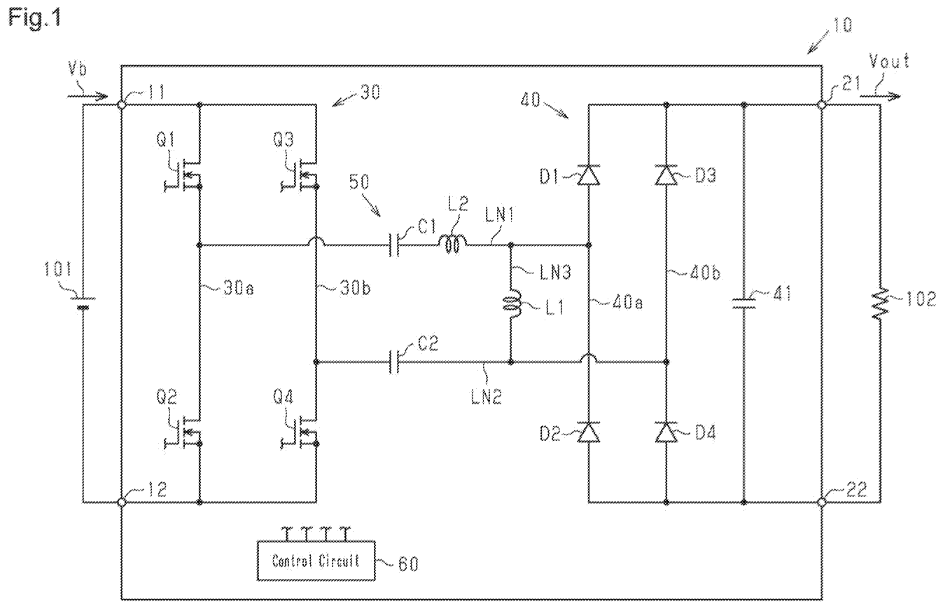

As shown in FIG. 1, the capacitive isolation type power conversion device 10 of the present embodiment is connected to, for example, a power storage device 101 and a load 102. Specifically, the capacitive isolation type power conversion device 10 includes input terminals 11, 12 and output terminals 21, 22. The input terminals 11, 12 are connected to the power storage device 101, and the output terminals 21, 22 are connected to the load 102.

The capacitive isolation type power conversion device 10 is a DC/DC converter device that converts DC power of a discharge voltage Vb input to the input terminals 11, 12 from the power storage device 101 into DC power of a desired voltage and outputs the DC power to the load 102 via the output terminals 21, 22. In the present embodiment, the DC power of the discharge voltage Vb corresponds to input power.

The capacitive isolation type power conversion device 10 includes a primary side circuit 30, a secondary side circuit 40, a first connection line LN1, a second connection line LN2, a third connection line LN3, and a resonant circuit 50.

The primary side circuit 30 includes switching elements Q1 to Q4. The primary side circuit 30 converts the input power into AC power by alternately switching the switching elements Q1 to Q4 between an ON state and an OFF state at specified switching frequency f.

For example, the primary side circuit 30 includes a first upper arm switching element Q1 and a first lower arm switching element Q2, which are connected in series to each other by a first intermediate line 30a, and a second upper arm switching element Q3 and a second lower arm switching element Q4, which are connected in series to each other by a second intermediate line 30b.

The primary side circuit 30 is connected to the input terminals 11, 12. Specifically, the upper arm switching elements Q1, Q3 are connected to the input terminal 11, and the lower arm switching elements Q2, Q4 are connected to the second input terminal 12. The DC power of the discharge voltage Vb is input to the primary side circuit 30.

The secondary side circuit 40 converts the AC power input from the connection lines LN1, LN2 into DC power, in other words, rectifies the AC power. The secondary side circuit 40 is connected to the output terminals 21, 22, and the DC power converted by the secondary side circuit 40 is output from the output terminals 21, 22.

The secondary side circuit 40 includes, for example, a diode bridge. Specifically, the secondary side circuit 40 includes a first upper arm diode D1 and a first lower arm diode D2, which are connected to each other in the forward direction by a third intermediate line 40a, and a second upper arm diode D3 and a second lower arm diode D4, which are connected to each other in the forward direction by a fourth intermediate line 40b. The secondary side circuit 40 includes a smoothing capacitor 41, which smooths the DC power output from the diode bridge.

The connection lines LN1, LN2 connect the primary side circuit 30 and the secondary side circuit 40 to each other. In other words, the connection lines LN1, LN2 are connected to the primary side circuit 30, and the secondary side circuit 40 is connected to the primary side circuit 30 by the connection lines LN1, LN2. Specifically, the first connection line LN1 connects the first intermediate line 30a and the third intermediate line to each other, and the second connection line LN2 connects the second intermediate line 30b and the fourth intermediate line 40b to each other.

The resonant circuit 50 includes a first capacitor C1 provided on the first connection line LN1 and a second capacitor C2 provided on the second connection line LN2. The primary side circuit 30 and the secondary side circuit 40 are connected to each other via the capacitors C1, C2.

The capacitances of the two capacitors C1, C2 are, for example, identical. However, the capacitances of the capacitors C1, C2 may be different from each other.

The third connection line LN3 is closer to the secondary side circuit 40 than the capacitors C1, C2. In other words, the third connection line LN3 is located between the capacitors C1, C2 and the secondary side circuit 40. In this specification, terms indicating positional relationships, such as “closer to” or “between” refer to circuitry positional relationships rather than spatial relationships. The third connection line LN3 connects the connection lines LN1 and LN2 to each other. Specifically, a section of the first connection line LN1 that connects the first capacitor C1 to the secondary side circuit 40 and a section of the second connection line LN2 that connects the second capacitor C2 to the secondary side circuit 40 are connected to each other by the third connection line LN3. The resonant circuit 50 of the present embodiment includes an excitation inductor L1 and a resonant inductor L2.

The excitation inductor L1 is provided on the third connection line LN3. The excitation inductor L1 may be formed by a dedicated coil or by parasitic inductance in the third connection line LN3. The inductance of the excitation inductor L1 is, for example, higher than the inductance of the resonant inductor L2. For illustrative purposes, the current flowing through the excitation inductor L1 in the following description will also be referred to as an excitation current.

The resonant inductor L2 is provided, for example, on the first connection line LN1. The resonant inductor L2 may be formed by a dedicated coil or by parasitic inductance in the first connection line LN1.

In the present embodiment, the resonant inductor L2 is closer to the primary side circuit 30 than the excitation inductor L1. In other words, the resonant inductor L2 is provided between the excitation inductor L1 and the primary side circuit 30. Specifically, the resonant inductor L2 is provided in a section of the first connection line LN1 between a node with the first capacitor C1 and a node with the third connection line LN3. Thus, the excitation current also flows through the resonant inductor L2. This also generates a counter-electromotive force in the resonant inductor L2. That is, in the present embodiment, the inductors L1, L2 function as inductance components that are excited by switching operations of the switching elements Q1 to Q4.

The resonant circuit 50 of the present embodiment includes the capacitors C1, C2 and the inductors L1, L2. The primary side circuit 30 and the secondary side circuit 40 are connected to each other via the resonant circuit 50.

With the above-described configuration, the primary side circuit 30 and the secondary side circuit 40 are isolated from each other by the capacitors C1, C2. Specifically, the capacitors C1 and C2 block or restrict transmission of DC power between the primary side circuit 30 and the secondary side circuit 40. On the other hand, the capacitors C1, C2 allow transmission of AC power through them.

That is, in the present embodiment, the capacitive isolation type refers to a type in which the capacitors C1, C2 blocks transmission of DC power between the primary side circuit 30 and the secondary side circuit 40, while allowing transmission of AC power between the primary side circuit 30 and the secondary side circuit 40.

The resonant circuit 50 of the present embodiment has two resonance frequencies fm1 and fm2. The first resonance frequency fm1 is determined by the capacitances of the capacitors C1, C2 and the inductances of the inductors L1, L2. The second resonance frequency fm2 is determined by the capacitances of the capacitors C1, C2 and the inductance of the resonant inductor L2. The second resonance frequency fm2 is higher than the first resonance frequency fm1.

As shown in FIG. 1, the capacitive isolation type power conversion device 10 includes a control circuit 60, which is a control unit that controls the switching elements Q1 to Q4 of the primary side circuit 30.

The control circuit 60 may be, for example, processing circuitry that includes a memory and a central processing unit. The memory stores programs used to execute a control process for controlling the switching elements Q1 to Q4 and necessary information, and the central processing unit executes control processes based on the programs.

However, the present disclosure is not limited to this, and the control circuit 60 may be, for example, processing circuitry that includes a dedicated hardware circuit, or processing circuitry that includes a combination of one or more dedicated hardware circuits and a CPU that executes software processing. In other words, the specific configuration of the control circuit 60 is not particularly limited. The control circuit 60 may be processing circuitry that includes, for example, at least one of a set of one or more dedicated hardware circuits and a set of one or more processors that operate in accordance with a computer program (software).

The control circuit 60 alternately switches the switching elements Q1 to Q4 between an ON state and an OFF state according to a specified switching pattern.

For example, the first upper arm switching element Q1 and the second lower arm switching element Q4 may be in the ON state, while the first lower arm switching element Q2 and the second upper arm switching element Q3 are in the OFF state. This switching pattern is referred to as a first pattern. Also, the first upper arm switching element Q1 and the second lower arm switching element Q4 may be in the OFF state, while the first lower arm switching element Q2 and the second upper arm switching element Q3 are in the ON state. This switching pattern is referred to as a second pattern. The control circuit 60 alternately switches the switching pattern between a first pattern and a second pattern at the switching frequency f. This converts the DC power of the discharge voltage Vb to AC power.

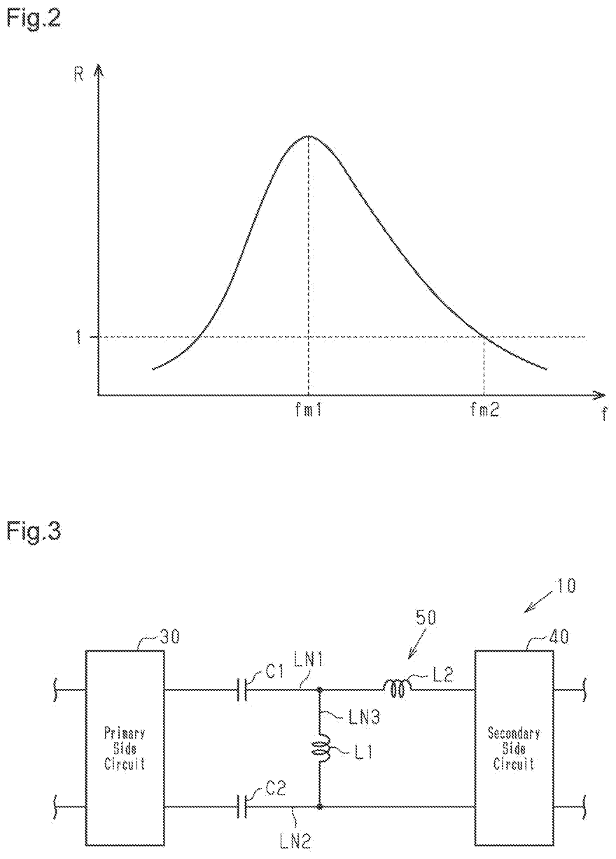

The control circuit 60 of the present embodiment controls the switching frequency f to thereby control an output voltage Vout, which is the voltage of the DC power output from the secondary side circuit 40, in other words, the output terminals 21,22. This point will be described in detail below with reference to FIG. 2. FIG. 2 is a graph schematically showing a conversion ratio R as a function of the switching frequency f. The conversion ratio R is a ratio of the output voltage Vout to the discharge voltage Vb.

As shown in FIG. 2, the conversion ratio R varies depending on the switching frequency fin the capacitive isolation type power conversion device 10 of the present embodiment. Specifically, the conversion ratio R is maximized when the switching frequency f is the first resonance frequency fm1. The maximum value of the conversion ratio R is greater than 1. As the switching frequency f is greater than the first resonance frequency fm1 and increases, the conversion ratio R decreases. The conversion ratio R is 1 when the switching ratio f is the second resonance frequency fm2. When the switching frequency f is higher than the second resonance frequency fm2, the conversion ratio R is less than 1.

That is, if the switching frequency f is in a range of the first resonance frequency fm1 to the second resonance frequency fm2 (fm1≤f≤fm2), the conversion ratio R is greater than or equal to 1, and thus the output voltage Vout is greater than or equal to the discharge voltage Vb. In other words, when the switching frequency f is in the range of the first resonance frequency fm1 to the second resonance frequency fm2, the capacitive isolation type power conversion device 10 performs a step-up operation.

Under the condition of fm1≤f≤fm2, each of the switching elements Q1 to Q4 can perform switching with the voltage at 0V. That is, under the condition of fm1≤f≤fm2, the turn-on of each of the switching elements Q1 to Q4 is zero voltage switching (ZVS). In other words, the switching method when the switching elements Q1 to Q4 are turned on under the condition of fm1≤f≤fm2 is a soft switching method.

Under the condition of fm1≤f≤fm2, operation of each of the diodes D1 to D4 of the secondary side circuit 40 is zero current switching (ZCS). Accordingly, a recovery current is unlikely to be generated, and thus, a diode with a low forward voltage can be used. This reduces the loss.

On the other hand, when the switching frequency f is greater than the second resonance frequency fm2 (f>fm2), the conversion ratio R is less than 1, and thus the output voltage Vout is lower than the discharge voltage Vb. That is, when the switching frequency f is higher than the second resonance frequency fm2, the capacitive isolation type power conversion device 10 performs a step-down operation. The control circuit 60 controls the switching frequency f based on, for example, the discharge voltage Vb and the above-described frequency characteristics so that a desired output voltage Vout is output. Specifically, the control circuit 60 derives a target conversion ratio R based on the discharge voltage Vb and the target value of the output voltage Vout, and controls each of the switching elements Q1 to Q4 at the switching frequency f at which the target conversion ratio R is obtained.

For example, when performing a step-up operation, the control circuit 60 controls the switching frequency f within a range of the first resonance frequency fm1 to the second resonance frequency fm2. When performing a step-down operation, the control circuit 60 controls the switching frequency f to be higher than the second resonance frequency fm2.

Operation of the present embodiment will now be described.

The switching elements Q1 to Q4 are alternately switched between an ON state and an OFF state at the switching frequency f, whereby power conversion is performed. In the present embodiment, the primary side circuit 30 converts the DC power of the discharge voltage Vb into AC power, and the primary side circuit 30, the capacitors C1, C2, and the excitation inductor L1 perform voltage conversion. Then, the secondary side circuit 40 rectifies the voltage-converted AC power. In this case, the switching frequency f is changed, so that the conversion ratio R is changed and the output voltage Vout is changed.

The present embodiment, which has been described above, achieves the following advantages.
(1) The capacitive isolation type power conversion device 10 includes the primary side circuit 30, the first connection line LN1 and the second connection line LN2, which are connected to the primary side circuit 30, the first capacitor C1, the second capacitor C2, the third connection line LN3, the excitation inductor L1, the secondary side circuit 40, and the control circuit 60, which is a control unit.
The primary side circuit 30 includes the switching elements Q1 to Q4. The primary side circuit 30 converts the DC power of the discharge voltage Vb, which is the input power, into AC power by alternately switching the switching elements Q1 to Q4 between an ON state and an OFF state at the specified switching frequency f. The capacitors C1, C2 are respectively provided on the connection lines LN1, LN2. The third connection line LN3 is closer to the secondary side circuit 40 than the capacitors C1, C2 and connects the first connection line LN1 and the second connection line LN2 to each other. The excitation inductor L1 is provided on the third connection line LN3. The secondary side circuit 40 is connected to the primary side circuit 30 by the connection lines LN1, LN2 via the capacitors C1, C2. The secondary side circuit 40 converts AC power input from the connection lines LN1, LN2 into DC power. The control circuit 60 controls the switching elements Q1 to Q4. The control circuit 60 controls the switching frequency f, thereby controlling the output voltage Vout, which is the voltage of the DC power output from the secondary side circuit 40.
With this configuration, the switching elements Q1 to Q4 are alternately switched between the ON state and the OFF state at the switching frequency f, so that the capacitive isolation type power conversion device 10 performs power conversion to convert input power into DC power.
Since the capacitors C1, C2 are interposed between the primary side circuit 30 and the secondary side circuit 40, the primary side circuit 30 and the secondary side circuit 40 are isolated from each other. Accordingly, even when an anomaly occurs due to some cause, it is possible to suppress transmission of the DC power between the primary side circuit 30 and the secondary side circuit 40, and thus it is possible to improve safety.
In particular, in the present embodiment, isolation is achieved not by a transformer but by the two capacitors C1, C2. In general, the capacitors C1, C2 are lighter, smaller, and less expensive than transformers. As a result, compared to the configuration that uses a transformer, it is possible to achieve weight reduction, miniaturization, and cost reduction.
In the capacitive isolation type power conversion device 10, which includes the capacitors C1, C2 and the excitation inductor L1, the conversion ratio R, which is the ratio of the output voltage Vout to the discharge voltage Vb of the input power, changes in accordance with the switching frequency f. Taking advantage of this characteristic, the control circuit 60 of the present embodiment controls the output voltage Vout by controlling the switching frequency f. As a result, it is possible to control the output voltage Vout in the configuration in which the capacitors C1, C2 are used for isolation.
(2) The capacitive isolation type power conversion device 10 includes the resonant inductor L2, which is provided on the first connection line LN1 or the second connection line LN2, and the resonant circuit 50, which includes the capacitors C1, C2 and the inductors L1, L2. In the present embodiment, the resonant inductor L2 is provided on the first connection line LN1.
Since this configuration can turn on each of the switching elements Q1 to Q4 through ZVS, the loss is reduced and surges are suppressed.
(3) The resonant inductor L2 is closer to the primary side circuit 30 than the excitation inductor L1.
With this configuration, the excitation current, which is the current that flows through the excitation inductor L1, also flows through the resonant inductor L2. As a result, the resonant inductor L2 also functions as an inductance component excited by switching operations of the switching elements Q1 to Q4, so that the inductance of the excitation inductor L1 is reduced. This, for example, reduces the size of the excitation inductor L1.
(4) The resonant circuit 50 has two types of resonance frequencies fm1 and fm2. The first resonance frequency fm1 is based on the capacitances of the capacitors C1, C2 and the inductances of the inductors L1, L2. The second resonance frequency fm2 is based on the capacitances of the capacitors C1, C2 and the inductance of the resonant inductor L2. The second resonance frequency fm2 is higher than the first resonance frequency fm1.
With this configuration, when performing a step-up operation, the control circuit 60 controls the switching frequency f within the range of the first resonance frequency fm1 to the second resonance frequency fm2. When performing a step-down operation, the control circuit 60 controls the switching frequency f to be higher than the second resonance frequency fm2.
This configuration can perform both step-up and step-down by controlling the switching frequency f.

The above-described embodiment may be modified as follows. The above-described embodiment and the following modifications may be combined as long as the combined modifications remain technically consistent with each other.

As shown in FIG. 3, the resonant inductor L2 may be closer to the secondary side circuit 40 than the excitation inductor L1. In other words, the resonant inductor L2 may be provided between the excitation inductor L1 and the secondary side circuit 40. For example, the resonant inductor L2 may be provided in a section of the first connection line LN1 between the node with the secondary side circuit 40 and the node with the third connection line LN3. In this case, since it is possible to suppress the excitation current from flowing through the resonant inductor L2, it is possible to reduce the loss caused by the resonant inductor L2.

The resonant inductor L2 and the first capacitor C1 may be arranged in reverse order. Specifically, the resonant inductor L2 may be closer to the primary side circuit 30 than the first capacitor C1.

The specific circuit configuration of the primary side circuit 30 may be changed if the primary side circuit 30 is capable converting input power to AC power.

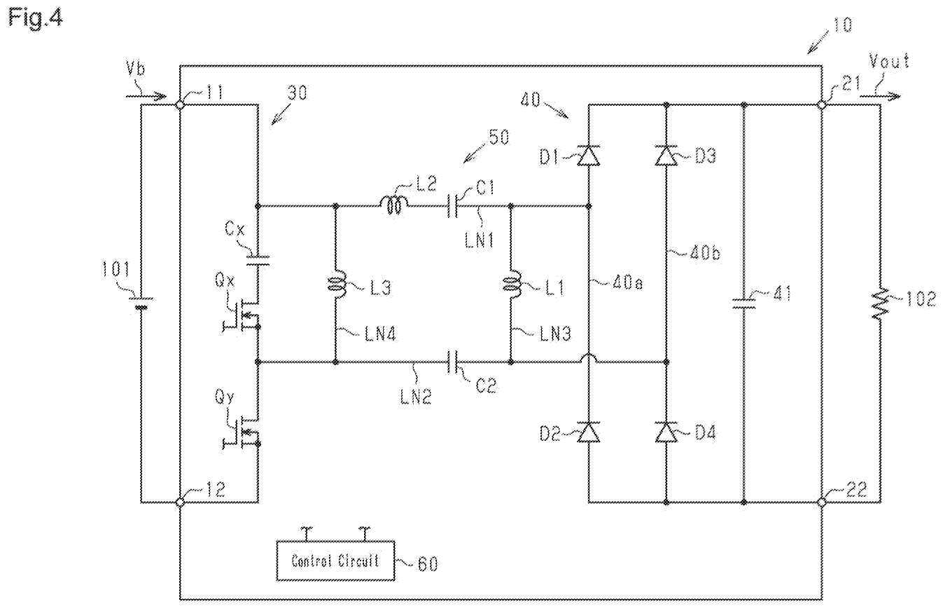

For example, as shown in FIG. 4, the primary side circuit 30 may include a series capacitor Cx, an upper arm switching element Qx, and a lower arm switching element Qy, which are connected together in series. The series connection of the series capacitor Cx and the arm switching elements Qx, Qy is connected to the input terminals 11 and 12.

In this case, the first connection line LN1 connects the secondary side circuit 40 to a line that connects the first input terminal 11 and the series capacitor Cx to each other. The second connection line LN2 connects the secondary side circuit 40 to a line that connects the arm switching elements Qx and Qy to each other.

The specific circuit configuration of the resonant circuit 50 is not particularly limited. As shown in FIG. 4 the capacitive isolation type power conversion device 10 may include a fourth connection line LN4 in addition to the third connection line LN3. The fourth connection line LN4 is closer to the primary side circuit 30 than, for example, the resonant inductor L2 and the capacitors C1, C2. Specifically, a section of the first connection line LN1 that connects the primary side circuit 30 to the resonant inductor L2 and a section of the second connection line LN2 that connects the primary side circuit 30 to the second capacitor C2 are connected to each other by the fourth connection line LN4.

The resonant circuit 50 includes a second excitation inductor L3 provided on the fourth connection line LN4 in addition to the first excitation inductor L1 provided on the third connection line LN3. In other words, the resonant circuit 50 of the present modification includes the capacitors C1, C2 and the inductors L1, L2, L3.

With this configuration, the output voltage Vout varies depending on the duty cycle of the arm switching elements Qx, Qy.″ Thus, the control circuit 60 controls the duty cycle of the arm switching elements Qx, Qy to control the output voltage Vout. As a result, it is possible to obtain the desired output voltage Vout while isolating the primary side circuit 30 and the secondary side circuit 40 from each other using capacitors C1, C2.

The control circuit 60 may be configured to control the output voltage Vout by controlling the phase of the AC power flowing through the primary side circuit 30. In other words, the capacitive isolation type power conversion device 10 may also be a phase-shift type DC/DC converter.

In essence, the capacitive isolation type power conversion device 10 may be configured to include the primary side circuit 30 with switching elements, the secondary side circuit 40, the connection lines LN1, LN2, the capacitors C1, C2, and the excitation inductor L1, such that the output voltage Vout varies depending on the switching frequency f, the duty cycle, or the phase. The control circuit 60 may be configured to control the output voltage Vout by controlling the switching frequency f, the duty cycle, or the phase.

The specific circuit configuration of the secondary side circuit 40 is not particularly limited if AC power input from the resonant circuit 50 can be converted into DC power. For example, the secondary side circuit 40 may include secondary side switching elements instead of diodes, and may be configured to perform power conversion by turning on and off the secondary side switching elements at the switching frequency f.

The secondary side circuit 40 may convert the AC power input from the resonant circuit 50 into DC power while stepping up or stepping down the voltage of the AC power. In this case, the output voltage Vout may be controlled by controlling the secondary side circuit 40 in addition to the switching frequency f, the duty cycle of the switching elements Q1 to Q4, or the phase of the AC power flowing through the primary side circuit 30. That is, the capacitive isolation type power conversion device 10 is not limited to controlling the output voltage Vout by using only the primary side circuit 30.

The resonant circuit 50 may include elements other than the capacitors C1, C2 and the inductors L1, L2. In essence, the resonant circuit 50 may include at least the capacitors C1, C2 and the inductors L1, L2.

The resonant inductor L2 may be provided on the second connection line LN2. The resonant inductor L2 may be provided on both the first connection line LN1 and the second connection line LN2.

The resonant inductor L2 may be omitted. Even in this case, the capacitive isolation type power conversion device 10 is capable of performing power conversion. However, considering the fact that soft-switching can be achieved when the switching elements Q1 to Q4 are turned on, the capacitive isolation type power conversion device 10 preferably includes the resonant inductor L2.

The capacitive isolation type power conversion device 10 may additionally include a DC/DC conversion circuit or a DC/AC conversion circuit provided between the secondary side circuit 40 and the output terminals 21, 22.

The capacitive isolation type power conversion device 10 does not necessarily need to be a DC/DC converter. For example, the capacitive isolation type power conversion device 10 may be an AC/DC converter that receives AC power as the input power and converts the AC power into DC power. In other words, the input power is not limited to the power of the power storage device 101, for example, it may be AC power. In this case, the capacitive isolation type power conversion device 10 may include a rectifier circuit that rectifies the input power and outputs the rectified power to the primary side circuit 30.

1. A capacitive isolation type power conversion device, comprising:
a primary side circuit that includes a switching element, the primary side circuit being configured such that the switching element are alternately switched between an ON state and an OFF state at a specified switching frequency, so that an input power is converted to an AC power;
a first connection line and a second connection line that are connected to the primary side circuit;
a first capacitor provided on the first connection line;
a second capacitor provided on the second connection line;
a secondary side circuit that is connected to the primary side circuit by the first and second connection lines via the first and second capacitors, the secondary side circuit being configured to convert an AC power input from the first and second connection lines to a DC power;
a third connection line that is provided closer to the secondary side circuit than the first capacitor and the second capacitor, the third connection line connecting the first connection line and the second connection line to each other;
an excitation inductor provided on the third connection line;
a resonant inductor that is provided on the first connection line or the second connection line;
a resonant circuit that includes the first and second capacitors, the resonant inductor, and the excitation inductor; and
a control circuit configured to control the switching element,
wherein the control circuit is configured to control an output voltage, which is a voltage of the DC power output from the secondary side circuit, by controlling the switching frequency, a duty cycle of the switching element, or a phase of the AC power flowing through the primary side circuit.

2. The capacitive isolation type power conversion device according to claim 1, wherein the resonant inductor is closer to the primary side circuit than the excitation inductor.

3. The capacitive isolation type power conversion device according to claim 2, wherein
the resonant circuit has:
a first resonance frequency based on capacitances of the first and second capacitors, an inductance of the excitation inductor, and an inductance of the resonant inductor; and
a second resonance frequency based on the capacitances of the first and second capacitors, and an inductance of the resonant inductor,
the second resonance frequency is higher than the first resonance frequency, and
the control circuit is configured to
when performing a step-up operation, control the switching frequency within a range of the first resonance frequency to the second resonance frequency, and
when performing a step-down operation, control the switching frequency to be higher than the second resonance frequency.

4. The capacitive isolation type power conversion device according to claim 1, wherein the resonant inductor is closer to the secondary side circuit than the excitation inductor.

5. (canceled)
